(19) United States
(12) Patent Application Publication
(10) Pub. No.: US 2005/0215105 A1
(43) Pub. Date: Sep. 29, 2005

(54) Fitting member and manufacturing method thereof

(75) Inventor: Hiroshi Kobayashi, Kariya-shi (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: AISIN SEIKI KABUSHIKI KAISHA, Kariya-shi (JP)

(21) Appl. No.: 11/080,644

(22) Filed: Mar. 16, 2005

(30) Foreign Application Priority Data
Mar. 25, 2004 (JP) 2004-089943

(51) Int. Cl. H01R 13/627

(52) U.S. Cl. 439/352

(57) ABSTRACT

A fitting member that forms, together with a fitted member, a fitting structure between a protruding portion and a hole portion, the fitting member comprises a fitting member unit and a lubricating layer that covers the fitting member unit, wherein the lubricating layer includes a synthetic resin layer that has more elasticity than material used for the fitting member unit and inorganic particles that protrude from a surface of the synthetic resin layer.

This application is based on and claims priority under 35 U.S.C. § 119 to Japanese Patent Application 2004-089943, filed on Mar. 25, 2004, the entire content of which is incorporated herein by reference.

### FIELD OF THE INVENTION

This invention generally relates to a fitting member for forming, together with a fitted member, a fitting structure between a protruding portion and a hole portion, and a manufacturing method for the fitting member.

### BACKGROUND

A fitting member forms, together with a fitted member, a fitting structure between a shaft and a bearing. The fitting member is formed so as to correspond to a structure or a dimension of the fitted member. When the fitting member forms, together with the fitted member, the fitting structure between a shaft and a bearing by means of a running fit, a interference fit or the like, the fitting structure requires a high level of dimensional accuracy. Thus, a cold forging needs to be preformed on several occasions and an accurate cutting operation needs to be applied when the fitting member is manufactured from a typical metal material, and all this results in high costs.

Consideration has been given to reducing costs for processing the fitting member by using either a metal material that has a cold forging property, or a synthetic resin that can be easily formed by a molding process. Such technology is in practice current technology, and there is thus no related art worth mentioning here.

A mounting structure, in which an electromagnetic valve for controlling a hydraulic pressure of a transmission is mounted to the transmission for a vehicle, has up to now been known as a concrete example of a fitting structure between a shaft and a bearing. Such a fitting structure is disclosed in JP H06-241333A (FIG. 1 and FIG. 3). Specifically, as shown in FIG. 2, a base portion 11 including a protruding portion of the electromagnetic valve, which serves as a fitting member, is fitted into a hole portion of the transmission, which serves as a fitted member, and thus the electromagnetic valve is mounted to the transmission. The base portion 11 of the electromagnetic valve and the hole portion of the transmission are precisely formed in such a way that a clearance of the fitting structure between a shaft and a bearing is set at between 10 μm and 15 μm for preventing hydraulic oil from leaking from a space that exists between the base portion 11 of the electromagnetic valve and the hole portion of the transmission.

In the above example, the fitting structure between the transmission and the electromagnetic valve is subjected to an external force at a fitting portion as a result of factors such as vibrations of the transmission, and fluctuations in hydraulic pressure. In consequence, an outer surface of the base portion 11 of the electromagnetic valve slides along an inner surface of the hole portion of the transmission. Thus, in order to enhance the wear resistance of the base portion 11 and the hole portion, the base portion 11 and the hole portion are normally made of an aluminium material that has a high silicon content.

When the base portion 11 of the electromagnetic valve is made of either a metal material or a synthetic resin that is soft and incorporates an appropriate cold forging property, only the base portion 11 of the electromagnetic valve wears away because of such sliding. Consequently, the clearance between the fitting member and the fitted member extends beyond a tolerable range, and as a result, there is on occasions a danger that hydraulic oil may leak from the clearance.

The transmission and the electromagnetic valve are used in atmospheric conditions in which a temperature is set at between −40° C. and 150° C. Because, when the base portion 11 of the electromagnetic valve is made of, in particular a synthetic resin, the coefficient of thermal expansion is high, a dimensional change caused by heat in an outer diameter of the base portion 11 becomes greater than a dimensional change in an inner diameter of the metal hole portion of the transmission. Thus, contact pressure between the base portion 11 and the hole portion is intensified, as a result, it becomes easier for the base portion 11 to wear away. Further, when the base portion 11 of the electromagnetic valve is formed by a molding process, it becomes difficult to control the dimensional accuracy of the base portion 11, and thus set the clearance of the fitting structure at between 10 μm and 15 μm as described above.

As is evident from above, applications to which such a fitting member, which is made of a metal material having an appropriate cold forging property or a synthetic resin having an appropriate moldability, can be put, have up to now been is limited.

A need thus exists to provide a fitting member and a manufacturing method thereof, by which, irrespective of the type of material used for the fitting member unit, wear resistance of the fitting member can be enhanced, and the costs of the forming process of the fitting member can be reduced by improving the dimensional tolerance of the fitting member. The present invention has been made in view of the above circumstances and provides both such a fitting member and an appropriate manufacturing method.

### SUMMARY OF THE INVENTION

According to an aspect of the present invention, a fitting member which forms, together with a fitted member, a fitting structure between a protruding portion and a hole portion, comprises a fitting member unit and a lubricating layer that covers the fitting member unit, wherein the lubricating layer includes a synthetic resin layer that has more elasticity than material used for the fitting member unit and inorganic particles that protrude from a surface of the synthetic resin layer.

According to another aspect of the present invention, a manufacturing method for a fitting member, according to which a lubricating layer is formed in which inorganic particles protrude from a surface of a synthetic resin layer, comprises a process for applying to the surface of the fitting member unit a synthetic resin solution, into which the inorganic particles have been dispersed, a process for evaporating a solvent of the synthetic resin solution, and a process for drying and solidifying a solute in the synthetic resin solution.

### BRIEF DESCRIPTION OF THE DRAWINGS

The foregoing and additional features and characteristics of the present invention will become more apparent from the following detailed description considered with reference to the accompanying drawings, wherein:

FIG. 1 illustrates a diagram for explaining a fitting member according to the present invention;

FIG. 2 illustrates a diagram of an electromagnetic valve for controlling a hydraulic pressure of a transmission, and

FIG. 3 illustrates a photograph of a alumina particles, which is formed by means of a gas flame spraying process.

### DETAILED DESCRIPTION

A fitting member according to the present invention forms, together with a fitted member, a fitting structure between a protruding portion and a hole portion, e.g. a shaft and a bearing. The fitting member comprises a fitting member unit and a lubricating layer that covers the fitting member unit. The lubricating layer includes a synthetic resin layer that has more elasticity than material used for the fitting member unit and inorganic particles that protrude from a surface of the synthetic resin layer. The fitting member according to the present invention can enhance its wear resistance and practically enhance a dimensional tolerance of the fitting member relative to the fitted member. Thus, irrespective of the type of the material of the fitting member unit, and irrespective of the type of the structure that forms the fitting structure, the fitting member according to the present invention can be used for various types of the fitting structure between the shaft and the bearing.

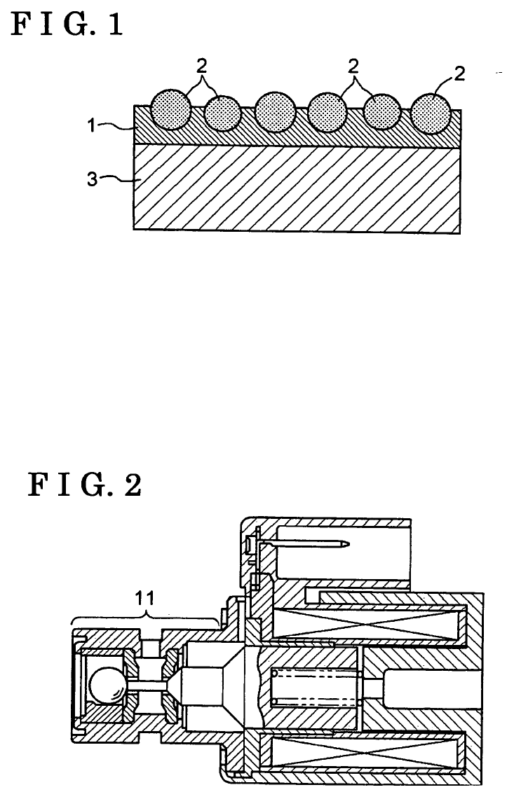

A general example of the lubricating layer of the fitting member will be explained with reference to FIG. 1. The fitting member includes the lubricating layer, in which inorganic particles 2 protrude from a surface of the synthetic resin layer 1, so as to cover a surface of the fitting member unit 3. Specifically, because the fitting member contacts with the fitted member (not shown) at fitting limited points through the inorganic particles 2, wear resistance on the fitting portion of the fitting member can be enhanced. Further, the synthetic resin layer 1 that has more elasticity than the fitting member unit 3 absorbs and reduces a contact pressure between the fitting member and the fitted member, as a result the frictional force of the fitting portion can also be reduced. Thus, friction on not only the fitting member, but also on the fitted member relative to the inorganic particles 2 can be reduced. Furthermore, the dimension in thickness of the fitting member can be changed by elastically deforming the synthetic resin layer 1 in thickness thereof, so that the dimensional tolerance of the fitting member relative to the fitted member can be enhanced.

The synthetic resin layer 1 contains a synthetic resin as a main element, which has more elasticity than the material used for the fitting member unit 3. Thus, the synthetic resin layer 1 absorbs an external force from the fitted member so as to prevent the external force from transmitting to the fitting member unit 3. The type of the synthetic resin is not limited, however, it is preferable to use a synthetic resin whose Young's modulus is low. Specifically, it is preferable to use a fluorocarbon polymer such as a fluorocarbon rubber, an acrylic rubber, a silicon rubber or the like. Further, a thickness of the synthetic resin layer 1 can be set at an appropriate value. For example, it is preferable that the thickness of the synthetic resin layer 1 is set at between 10 μm and 30 μm. Such synthetic resin layer 1 evenly can cover the surface of the fitting member unit 3 and absorbs the external force applied from the fitted member to the fitting member.

When the fitting member is used for the base portion 11 of the electromagnetic valve, which is used for a known transmission shown in FIG. 2, because the base portion 11 is exposed to a hydraulic oil for the transmission in atmospheric conditions in which a temperature is high, it is preferable that the synthetic resin layer 1 is made of a synthetic resin having heat resistance and oil resistance. Specifically, it is more preferable that the synthetic resin layer 1 is made of fluorocarbon polymers in which a tetrafluoroethylene monomer and a propylene monomer are copolymerized relative to a vinylidene fluoride monomer having cross-linking sites. Having durability against acid, alkalis and amine, the fluorocarbon polymers is applicable to the synthetic resin layer 1 of the base portion of the electromagnetic valve, which controls the hydraulic pressure of the engine.

Because the inorganic particles 2 directly contact with the fitted member, it is preferable to use inorganic particles having high hardness. Specifically, ceramic particles such as alumina, zirconia, titania or the like is used preferably. Further, when the inorganic particles 2 are used in atmospheric conditions in which a temperature is high, it is preferable that particles whose coefficient of thermal expansion is small are used. Furthermore, considering the cost issue, a alumina particles are specifically preferable to be used.

The diameter of the inorganic particles 2 can be freely set depending on the thickness of the synthetic resin layer 1. For example, when the thickness of the synthetic resin layer 1 is 10 μm, inorganic particles of 10-20 μm in diameter is preferred to be used as the inorganic particles 2. Specifically, if the diameter of each of the inorganic particles 2 is larger than 20 μm, the inorganic particles 2 extrude too much, and thus the bonding force between the synthetic resin layer 1 and the inorganic particles 2 will be reduced. In this point of view, it is preferable that the thickness of each of the inorganic particles 2 is set at between a thickness of the synthetic resin layer 1 and a thickness of approximately double thickness of the synthetic resin layer 1. Further, it is preferable that each of the inorganic particles 2 has approximately the same diameter so as to contact at the same pressure with the fitted member. Specifically, it is preferable that the inorganic particles 2 whose article size distribution is small is used for the fitting member. Furthermore, a percentage of the inorganic particles 2, which is mixed into the synthetic resin layer 1, is not limited. It is preferable that a percentage of the inorganic particles 2 relative to the synthetic resin layer 1 is set at between 20 vol. % and 30 vol. %. A surface area of the inorganic particles 2 that protrudes from the surface of the synthetic resin is not particularly limited. It is preferable that one-fifth of the surface area of each inorganic particle 2 protrude from the surface of the synthetic resin.

A material of the fitting member unit 3 is not particularly limited, and a known material can be used for the fitting member. For example, when the fitting member is used for the base portion 11 of the electromagnetic valve, which is shown in FIG. 2, an aluminium material can be used for the fitting member unit 3 in the same manner as a known fitting member. When the aluminium material is used, according to the present invention, the dimensional tolerance on the fitting member can be practically increased. Thus, there is no need to apply a complicated cutting process, and the degree of accuracy required in producing the fitting member can be correspondingly lowered, as a result the costs can be reduced. Further, it has been considered that a metal having appropriate cold forging property and a synthetic resin having appropriate moldability are difficult to use for the base portion 11 of the electromagnetic valve due to poor wear resistance, however, even when these materials are used for the fitting member unit 3, the wear resistance of the fitting member can be enhanced according to the present invention, and thus such the fitting member unit 3 can be preferably used for the base portion 11 of the electromagnetic valve.

When metal is used for the fitting member unit 3, a type of the metal is not particularly limited. Because of being easy to process, aluminium is preferred to be used for the fitting member unit 3. When synthetic resin is used for the fitting member unit 3, both a thermoplastic resin and a thermosetting resin can be used preferably, however, because of being easy to molding-process, the thermoplastic resin is preferred to be used for the fitting member unit 3. As the thermoplastic resin; a polysulfide resin, a polyester resin, a polyamide resin and a polycarbonate resin can be used depending on a purpose of application. Specifically, in view of heat resistance, moldability and chemical stability, a PPS (polyphenylene sulfide) resin, a PBT (polybutylene terephthalate) resin and a nylon resin are preferably used. A type of the resin used for the fitting member unit 3 is not limited to a single monomer, and a copolymerized resin or a compounder of plural types of resins can be used.

Even when synthetic resin is used in atmospheric conditions, in which a temperature is high, and the synthetic resin is thermally expanded, because the synthetic resin layer 1 is elastically deformed so as to absorb the expanded portion of the synthetic resin. Thus, the synthetic resin can be preferably used for the fitting member unit 3. Further, it is preferable that known glass fillers such as a quartz glass having a sphere form are mixed into the synthetic resin, which is used for the fitting member unit 3, so as to reduce a coefficient of linear expansion of the synthetic resin.

A coupling agent can be used for enhancing a bonding force between the synthetic resin 1 and the inorganic particles 2, and a bonding force between the synthetic resin 1 and the fitting member unit 3. A type of the coupling agent is not limited, and a known coupling agent can be preferably used. For example, a coupling agent including a functional group that bonds between the synthetic resin layer 1 and the inorganic particles 2, or a functional group that bonds between the synthetic resin layer 1 and the fitting member unit 3, can be used as a coupling agent. For example, a coupling agent that includes a Si—(OR)₃ (R: alkoxy group), which having an alkoxy group such as a methoxy group and an ethoxy group, is preferably used for the inorganic particles 2. Such the alkoxy group can be hydrolyzed by use of water that is absorbed on the surface of each of the inorganic particles 2, and then a silanol group (SiOH) is generated so as to bond with the surface of each of the inorganic particles 2. Even when the fitting member unit 3 made of metal, the same coupling agent can be used for bonding between the fitting member unit 3 and the synthetic resin layer 1. When the fitting member unit 3 is made of a synthetic resin, it is preferable that the coupling agent may include a functional group that reacts with a functional group of the synthetic resin. For example, when the synthetic resin layer 1 includes a carboxyl group, a coupling agent having an epoxy group or an amino group is preferably used. Further, when the fitting member unit 3 is made of a nylon resin or a PBT resin, a coupling agent having an amino group is preferably used. For example, NH₂C₃H₈Si(OC₂H₅)₃ or NH₂C₂H₄NHC₃H₈Si(OCH₃)₃ can be used as a coupling agent which can enhance a bonding force between the fluorocarbon polymer and the alumina.

Further, even when the synthetic resin is a PPS resin, which is not including a functional group that directly reacts with a coupling agent, the PPS resin can bond with the coupling agent by applying surface modification on the surface of the PPS resin. For example, by means of an atmospheric plasma exposure or an ultraviolet irradiation, a part of benzene rings of the PPS resin can be broken so as to generate a carboxyl group and a carbonyl group, and then the generated carboxyl group and carbonyl group react with the coupling agent that have an epoxy group or an amino group.

Irrespective of the type of the material of the fitting member unit 3, a fitting member according to the present invention can enhance the wear resistance of the fitting member and enhance the dimensional tolerance of the fitting member, as a result, the costs of the producing the fitting member can be reduced. Following is an example of a manufacturing method of the fitting member according to the present invention.

A manufacturing method for a fitting member, according to which a lubricating layer is formed in which the inorganic particles 2 protrude from a surface of the synthetic resin layer 1, comprises a process for applying the synthetic resin solution to the surface of the fitting member unit 3, into which the inorganic particles have been dispersed, a process for evaporating a solvent of the synthetic resin solution, and a process for drying and solidifying a solute in the synthetic resin solution. For example, the solution is applied to a surface of the fitting member unit 3 by means of a splaying or a dipping. To enhance the accuracy of the thickness of the lubricating layer so as to have a uniform level of the thickness, it is preferred that the solution is applied to the surface of the fitting member unit 3 by means of the splaying. A solvent is evaporated by means of a heating the solution at a temperature, which is equal to, or more than, a boil point of the solvent, as a result the synthetic resin is dried and solidified. Thus, the inorganic particles 2 can protrude from the surface of the synthetic resin layer 1 at a uniform level.

The solution is prepared as follows. A synthetic resin used for the synthetic resin layer 1 is dissolved into a solvent, in which the synthetic resin can be dissolved, so as to be at a particular viscosity, and then the inorganic particles 2 are mixed into the solution so as to be at an appropriate ratio. If a coupling agent for bonding the synthetic resin layer 1 and the inorganic particles 2, or a coupling agent for bonding the synthetic resin layer 1 and the fitting member unit 3 is used, such the coupling agent may be mixed at this point into the solution. For example, when fluorocarbon polymers are used for the synthetic resin layer 1, the fluorocarbon polymers can be dissolved into xylene, which can be preferably evaporated by a heat treatment at between 150° C. and 200° C. Further, the solution in which a synthetic resin is dissolved can also be prepared as follows. First, a composite material sheet, in which the inorganic particles 2 and the coupling agent are mixed, is prepared, and then the sheet is cut in pieces so as to be dissolved into the solvent. The synthetic resin that is used for the synthetic resin layer 1 is prepared by means of a known polymerising process. Alternatively, a synthetic resin on the market may be used.

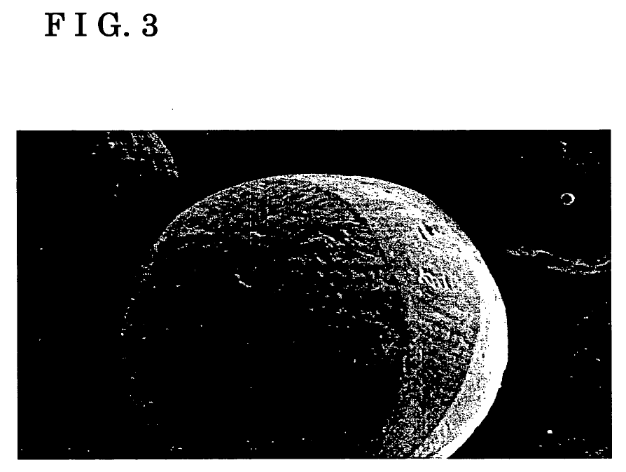

The inorganic particles 2 can be prepared by means of a known process. For example, when α alumina is used as the inorganic particles 2, a known process such as a Bayer process or a gas flame spraying process can be used. The gas flame spraying process is most preferable because sphere form alumina particles shown in FIG. 3 can be formed. Alternatively, inorganic particles on the market may be used as the inorganic particles 2.

The fitting member unit 3 can be preferably formed depending on the applicable fitting member. When the fitting member unit 3 is comprised of metal, the fitting member unit is manufactured by means of a forging or a cutting in the same manner as a known manufacturing process for the fitting member. When the fitting member unit 3 is comprised of a synthetic resin, the fitting member unit 3 can be manufactured by means of a molding process or a cutting. Specifically, by use of a synthetic resin layer 1 that is elastically deformed, the fitting member can be deformed in its thickness direction, In this circumstance, the fitting member unit 3 can be manufactured by means of a molding process or a cutting, which is not requiring a high dimensional accuracy, as a result, the manufacturing costs can be reduced.

The coupling agent can be prepared by means of an organic synthesis reaction depending on a type of the thermoplastic resin. Alternatively, a chemical compound on the market can be used. Further, an appropriate functional group can be added into such the chemical compound by means of the organic synthesis reaction.

A specific example of the fitting member according to the present invention will be explained below. In this example, the fitting member includes a synthetic resin layer 1 comprised of a fluorocarbon polymer, in which a tetrafluoroethylene and a propylene are copolymerized relative to a vinylidene fluoride; inorganic particles 2 comprised of α alumina particles, which is manufactured by means of the gas flame spraying process so as to be at 20 μm of its average particles diameter, and a fitting member unit 3 comprised of an aluminium material of JIS alloy number 6061, which has an appropriate cold forging property. Such the fitting member is used for the base portion 11 of the electromagnetic valve. The other configuration of the electromagnetic valve is the same as a configuration of a known electromagnetic valve.

The fluorocarbon polymers are dissolved into xylene so as to be at an approximately 1.8 pose. Then, the α alumina particles are added into the solution so as to be at between 10 vol. % and 20 vol. %. Further, a coupling agent having a molecular structure of NH₂C₃H₈Si(OC₂H₅)₃ is added into the solution, and thus the percentage thereof relative to the a alumina particles becomes at 1.5 wt %. Then, the solution have been agitated by means of a mixer for five minutes, and thus a solution in which fluorocarbon polymers are evenly dissolved can be prepared.

In addition, the base portion 11 of the electromagnetic valve is made of the above aluminium material by means of the known manufacturing method. In this example, the cutting process is skipped, and thus the tolerance range of the dimensional accuracy in an axial direction of the base portion 11 is set at between −10 μm and +10 μm.

The solution in which the fluorocarbon polymers are dissolved is sprayed on the surface of the base portion 11 of the electromagnetic valve so as to be at 30 μm in its thickness. Then, the base portion has been heated at 180° C. for 30 minutes so as to remove the xylene which serves as a solvent. Thus, a fluorocarbon polymer layer from which the alumina particles are evenly protruded is prepared. Because of such the layer, even if the dimensional accuracy of the base portion 11 of the electromagnetic valve is reduced, the electromagnetic valve is preferably fitted into a hole portion of a known transmission.

In this example, an aluminium material is used for the base portion 11 of the electromagnetic valve, however, the material of the base portion 11 is not limited. For example, a PPS resin having an appropriate heat resistance in atmospheric condition in which a temperature is 150° C., having a superior molding property and having a superior chemical stability can be alternatively used. In this example, the fitting member serves as the base portion 11 of the electromagnetic valve, however, the fitting member can be used for the hole portion of the transmission, or can be used for both the base portion 11 and the hole portion. In both circumstances, the same effect can be obtained.

The fitting member according to the present invention can be used for the base portion of the electromagnetic valve. The fitting member can also be used for various purposes such as a hole portion of the transmission or a hole portion of the engine.

According to the configuration of the present invention, the inorganic particles make contact with the fitting member and thus enhance the wear resistance of the fitting portion of the fitting member. Further, by means of the synthetic resin layer, which can be more easily elastically deformed than the fitting member unit, contact pressure between the fitting member and the fitted member can be absorbed and its level correspondingly reduced, The frictional force of the fitting portion can thus be lowered, and the wear resistance of the fitting member can be enhanced. Furthermore, because the frictional force of the fitting portion is reduced, as described above, it becomes difficult for both the fitted member and the inorganic particles to wear away.

According to the configuration of the present invention, by an elastic deformation of the synthetic resin layer, the thickness of the dimensions of the fitting member can be changed, when the fitting member is fitted into the fitted member, dimensional tolerance relative to the fitted member, can be enhanced, and the degree of accuracy required in producing the fitting member can be correspondingly lowered.

Furthermore, even when the fitting member unit is made of a material whose coefficient of thermal expansion is high, by means of a synthetic resin layer that is elastically deformed, a dimensional change of the fitting member unit under atmospheric conditions in which a temperature is high can be absorbed.

Thus, irrespective of the type of the material of the fitting member unit, a fitting member according to the present invention together with a manufacturing method thereof, can produce an improvement in the wear resistance of the fitting member and, by enhancing the dimensional tolerance of the fitting member, the costs of the producing the fitting member can be reduced. The fitting member according to the present invention may further be any member which forms a fitting structure between a shaft and a bearing.

According to the configuration of the present invention, because the fluorocarbon polymer displays a superior degree of elasticity, heat resistance and oil resistance, and the ceramic particles are of a high level of hardness, irrespective of the type of material used for the fitting member unit such the fluorocarbon polymer and the ceramic particles can be used for various applications.

The fitting member according to claim 2, wherein the ceramic particles are alumina particles.

Because, according to the configuration of the present invention, the alumina particles are cheap and of a low coefficient of thermal expansion, they can be used for applications in atmospheric conditions where the temperature needs to be high.

According to the configuration of the present invention, the lubricating layer includes the inorganic particles that protrude evenly, and the lubricating layer has a uniform level of thickness.

The principles, preferred embodiment and mode of operation of the present invention have been described in the foregoing specification. However, the invention which is intended to be protected is not to be construed as limited to the particular embodiments disclosed. Further, the embodiments described herein are to be regarded as illustrative rather than restrictive. Variations and changes may be made by others, and equivalents employed, without departing from the sprit of the present invention. Accordingly, it is expressly intended that all such variations, changes and equivalents which fall within the spirit and scope of the present invention as defined in the claims, be embraced thereby.

1. A fitting member that forms, together with a fitted member, a fitting structure between a protruding portion and a hole portion, the fitting member comprising:
a fitting member unit and
a lubricating layer that covers the fitting member unit, the lubricating layer including:
a synthetic resin layer that has more elasticity than material used for the fitting member unit and
inorganic particles that protrude from a surface of the synthetic resin layer.

2. The fitting member according to claim 1, wherein the synthetic resin layer is a resin layer that includes a fluorocarbon polymer, and the inorganic particles are ceramic particles.

3. The fitting member according to claim 2, wherein the ceramic particles are alumina particles.

4. The fitting member according to claim 1, wherein the synthetic resin layer is a fluorocarbon polymer, an acrylic rubber or a silicon rubber.

5. The fitting member according to claim 1, wherein the inorganic particles are ceramic particles that includes alumina, zirconia or titania.

6. The fitting member according to claim 1, wherein diameters of the inorganic particles are set between a thickness of the synthetic resin and a thickness of approximately double thereof.

7. A manufacturing method for a fitting member, according to which a lubricating layer is formed in which inorganic particles protrude from a surface of a synthetic resin layer, the manufacturing method comprising;
a process for applying to a surface of the fitting member unit a synthetic resin solution into which the inorganic particles have been dispersed,
a process for evaporating a solvent of the synthetic resin solution,
and a process for drying and solidifying a solute in the synthetic resin solution.

8. The manufacturing method for a fitting member according to claim 7, wherein a percentage of the inorganic particles relative to the synthetic resin layer mixed into the synthetic resin layer is set at between 20 vol. % and 30 vol. %.

9. The manufacturing method for a fitting member according to claim 7, wherein, when the fitting member unit is made of aluminum, the synthetic resin layer is a thermoplastic resin such as a polyphenylene sulfide (PPS) resin, a polybutylene terephthalate (PBT) resin or a nylon resin.

10. The manufacturing method for a fitting member according to claim 7, wherein the synthetic resin layer bonds with the fitting member unit by means of a coupling agent that includes an alkoxy group so as to bond with surfaces of the inorganic particles of the synthetic resin layer.
